(19) United States
(12) Patent Application Publication
(10) Pub. No.: US 2013/0322755 A1
(43) Pub. Date: Dec. 5, 2013

(54) IMAGE PROCESSING METHOD AND APPARATUS

(71) Applicant: CORE LOGIC INC., Seoul (KR)

(72) Inventors: Dae-Sik Seo, Seongnam-si (KR); Su-Hong Ahn, Seoul (KR)

(73) Assignee: CORE LOGIC INC., Seoul (KR)

(21) Appl. No.: 13/902,474

(22) Filed: May 24, 2013

(30) Foreign Application Priority Data
May 29, 2012 (KR) 10-2012-0056549

(51) Int. Cl. G06T 7/00

(52) U.S. Cl. CPC G06T 7/0085
USPC 382/173

(57) ABSTRACT

Disclosed herein is an image processing method and apparatus, which perform image processing after dividing a collected images into a plurality of image slices. The image processing method includes: receiving an image collected by an image sensor; determining image slice size information by taking into account a boundary area between a plurality of image slices to be generated; dividing the image into the plurality of image slices according to the image slice size information; and processing the plurality of image slices in sequence using division information about the image slices. Thus, in the image processing method, the image collected by the image sensor is processed by dividing the same into the plurality of image slices, thereby reducing the amount of memory used in image processing and the overall size of the image module.

### CROSS-REFERENCE TO RELATED APPLICATION

This application claims priority to Korean Patent Application No. 10-2012-0056549 filed on May 29, 2012, and all the benefits accruing therefrom under 35 U.S.C. § 119, the contents of which is incorporated by reference in its entirety.

### BACKGROUND

1. Technical Field

The present invention relates to an image processing method and apparatus, and more particularly, to an image processing method and apparatus, which perform image processing after dividing a collected image into a plurality of image slices.

2. Description of the Related Art

In general, an image sensor is a semiconductor device which converts an analog signal of light into an electric signal. Currently, cellular phones, smartphones, camera phones, personal digital assistants (PDAs), or the like terminal as well as digital cameras include a camera module, so that a function of capturing an image has become widespread. Such a camera module uses an image sensor such as a charged-coupled device (CCD) or a complementary metal-oxide semiconductor (CMOS) to capture an image of an object.

A typical image sensor has a pixel array of a Bayer pattern. The image sensor using the Bayer pattern includes a plurality of unit pixels that convert an optical signal of an object into an electric signal. Each unit pixel of the Bayer pattern includes information about one among Red/Green/Blue. Values of R, G and B detected by the respective unit pixels are converted into digital signals by an analog digital converter (ADC) included in the image sensor, and input to an image signal processor (ISP).

FIG. 1 is a block diagram of an apparatus for processing images collected by an image sensor having a Bayer pattern. Images collected by an image sensor 102 are input to and processed by an ISP block 104, and then stored as an image having a YUV format by a YUV Write block 118. The ISP block 104 includes a Defective Pixel Correction (DPC) block 106, a Lens Shading Correction (LSC) block 108, a Bayer Noise Reduction (BNR) block 110, a Color Interpolation (CI) block 112, a Gamma block 114, and a Chroma Suppression (CS) block 116. The functions of these blocks are well known in the art, and thus detailed descriptions thereof will be omitted.

On the other hand, certain blocks, for example, DPC 106, BNR 110, CI 112, etc. included in the ISP block 104 of FIG. 1 employ a mask filter. Thus, an image processing module including the ISP block 104 of FIG. 1 needs a memory amount corresponding to the size of an image processed by the corresponding block and the size of a mask filter needed by the corresponding block. Such a memory is called a line-buffer, and SRAM or the like is most often used as the line-buffer.

To process an image input by the image sensor 102 of FIG. 1 in real time, a larger mask filter is required. Further, the larger the mask filter, the larger the line-buffer needed by the ISP block 104. For example, a high performance image sensor uses a mask filter having a size of 17×17. In this case, the ISP needs sixteen line-buffers. Such increase of the line-buffer results in increasing the size of the ISP block, and furthermore increasing the overall size of the whole image processing module.

### BRIEF SUMMARY

An aspect of the present invention is to provide an image processing method and apparatus, which performs image processing after dividing an image collected by an image sensor into a plurality of image slices, thereby decreasing the amount of memory used in image processing and the overall size of the image module.

In accordance with one aspect of the present invention, a method of processing an image collected by an image sensor includes: receiving an image; determining image slice size information by taking into account a boundary area between a plurality of image slices to be generated; dividing the image into the plurality of image slices according to the image slice size information; and processing the plurality of image slices in sequence using division information about the image slices.

In accordance with another aspect of the present invention, an apparatus for processing an image collected by an image sensor includes: an input unit which receives an image; an image slice generator which determines image slice size information by taking into account a boundary area between a plurality of image slices to be generated, and divides the image into the plurality of image slices according to the image slice size information; and an image processor which processes the plurality of image slices in sequence using division information about the image slices.

The present invention is not limited to the above aspect, and other aspects, objects, features and advantages of the present invention will be understood from the detailed description of the following embodiments of the present invention. In addition, it will be readily understood that the aspects, objects, features and advantages of the present invention can be achieved by the accompanied claims and equivalents thereof.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 is a block diagram of a conventional image processing apparatus;

FIG. 2 is a block diagram of an image processing apparatus according to one embodiment of the present invention;

FIG. 3 is a block diagram of an image processing apparatus according to another embodiment of the present invention;

FIG. 4 is a block diagram of an image slice generator included in the image processing apparatus according to one embodiment of the present invention;

FIG. 5 is a view explaining a process of processing a boundary between images in an image processing method according to one embodiment of the present invention;

FIG. 6 is a view explaining a process of processing a boundary between image slices in the image processing method according to the embodiment of the present invention;

FIG. 7 is a view explaining a process of processing a boundary between image slices in the image processing method according to the embodiment of the present invention; and

FIG. 8 is a flowchart of the image processing method according to the embodiment of the present invention.

### DETAILED DESCRIPTION

Exemplary embodiments of the present invention will now be described in detail with reference to the accompanying drawings. It should be understood that the present invention is not limited to the following embodiments and may be embodied in different ways, and that the embodiments are given to provide complete disclosure of the invention and to provide thorough understanding of the invention to those skilled in the art. Descriptions of details apparent to those skilled in the art will be omitted for clarity of description. The like components will be denoted by the like reference numerals throughout the specification.

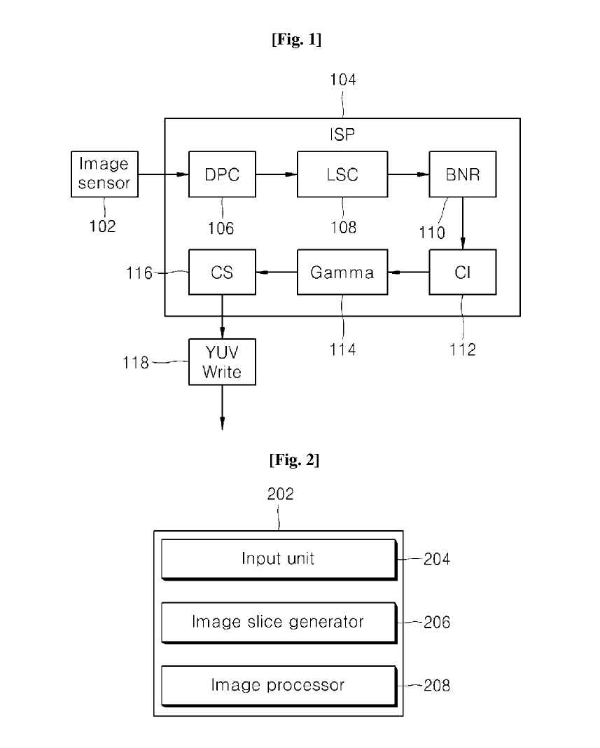

As described above, digital cameras, cellular phones, smartphones, camera phones, personal digital assistants (PDAs), other terminals, and the like include a camera module. Such a camera module generally employs an image sensor having a Bayer pattern, as shown in FIG. 1.

To process an image input by the image sensor 102 of FIG. 1 in real time, a larger mask filter is required. Further, the larger the mask filter, the larger the line-buffer needed by the ISP block 104. For example, a high performance image sensor employs a mask filter having a size of 17×17. In this case, the ISP needs sixteen line-buffers. Such increase of the line-buffer increases the size of the ISP block and, furthermore, increases the overall size of the image processing module.

The present invention is devised to solve such a problem, and thus provides an image processing method and apparatus, in which an image input through the image sensor is divided into a plurality of image slices and processed so as to reduce the amount of memory used in image processing and the overall size of the image module.

FIG. 2 is a block diagram of an image processing apparatus according to one embodiment of the present invention.

Referring to FIG. 2, an image processing apparatus 202 according to this embodiment includes an input unit 204, an image slice generator 206, and an image processor 208. The input unit 204 receives an image collected by an image sensor.

In this embodiment, the image slice generator 206 divides an image input through the input unit 204 into a plurality of image slices. The image slice generator 206 determines image slice size information in consideration of a boundary area between the plurality of image slices to be generated. In some embodiments, the image slice generator 206 may determine the image slice size information, i.e., information about the size of the image slice based on slice number information (information about the number of image slices to be generated), image size information (information about the size of the input image), and mask information (information about the size of the mask used in the image processor 208)

Then, the image slice generator 206 divides the input image into the plurality of image slices according to the determined image slice size information.

The image processor 208 uses division information about the image slices to thereby sequentially process the plurality of image slices. Here, the division information may include at least one of the slice number information and the image size information.

Although not shown in FIG. 2, the image processing apparatus 202 may further include an image slice merging unit. The image slice merging unit merges the plurality of image slices sequentially processed by the image processor 208 and thus generates one image. In one embodiment, the image slice merging unit may merge the plurality of image slices by taking the boundary area into account upon generation of the plural image slices. For example, the image slice merging unit may store the plurality of image slices except for a pixel added in determination of the image slice size information.

Next, configuration and operation of the image processing apparatus according to the embodiment will be described. In this embodiment, one image is divided into two image slices, and the ISP uses a mask filter having a size of 5×5, without being limited thereto. The present invention may be applied without any limitation as to the number of image slices and the size of the mask filter.

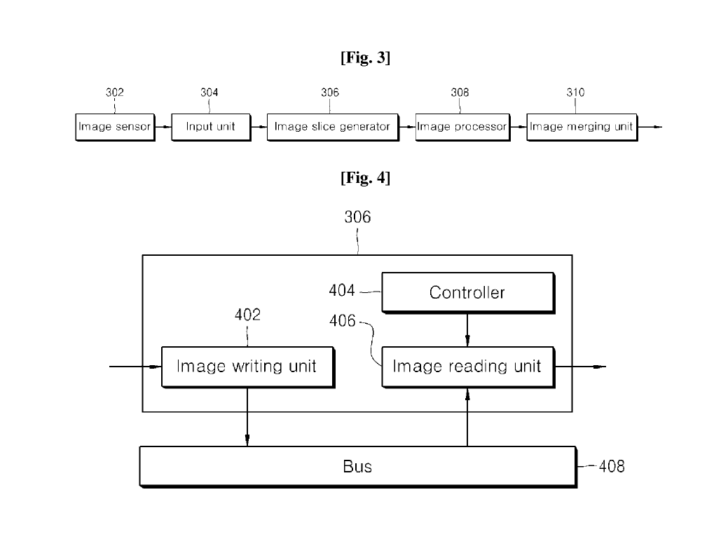

FIG. 3 is a block diagram of an image processing apparatus according to one embodiment of the present invention.

First, the input unit 304 receives images collected by the image sensor 302. Further, the image slice generator 306 divides the input image into two image slices.

In more detail, the image slice generator 306 determines the image slice size information based on the slice number information, the image size information, and mask information. In this embodiment, the number of image slices is 2. Further, the image input by the input unit 304 has a size (iWidth, iHeight), and the image processor 308 employs a mask having a size of 5×5. The size (sWidth, sHeight) of one slice is determined by the following expression:

sWidth=(iWidth/2)+(NM>>1); and

sHeight=iHeight.

In this embodiment, since the number of image slices is 2, iWidth is divided by 2 when determining sWidth. Also, ‘NM’ refers to the size of the mask, and ‘>>’ means a binary number shift operation. For example, in this embodiment, ‘NM’ is 5,and ‘>>1’ is ‘10’, i.e., ‘2’ as a result of shifting a binary number ‘101’ rightward by 1 bit.

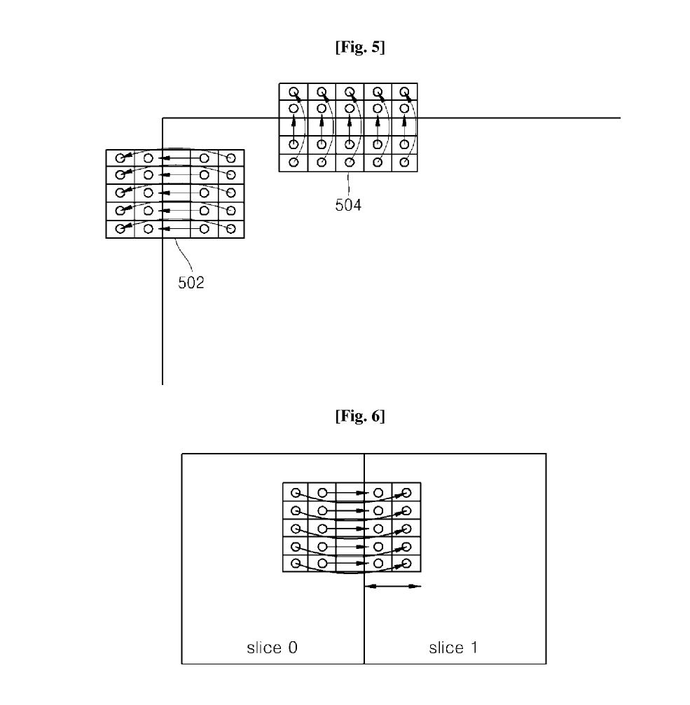

Here, it should be noted that in this embodiment, sWidth is determined based on a value obtained by adding ‘NM>>1’ to a value obtained by dividing iWidth by the number of image slices since the boundary area between the image slices is taken into account. For example, in a conventional image processing method, the boundary between the images is processed by sharing some pixels of a previous image with those of the next image in the boundary areas 502, 504 between the images, as shown in FIG. 5.

On the contrary, according to the present invention, since one image is divided into the plurality of image slices, the boundary area between the image slices is taken into account. That is, if two image slices are generated as shown in FIG. 6, slice 0 shares some pixels with slice 1 as shown in FIG. 5 in the boundary area between slice 0 and slice 1, thereby preventing defective pixels in the boundary area. As a result, ‘NM>>1′’ of the above expression refers to the size of pixels shared between the image slices.

According to such determined image slice size information, the image slice generator 306 divides the input image into two image slices.

Referring to FIG. 4, the image slice generator 306 according to one embodiment of the present invention will be described. FIG. 4 is a block diagram of an image slice generator 306 included in the image processing apparatus according to one embodiment.

The image slice generator 306 may include an image writing unit 402, a controller 404, and an image reading unit 406. The image writing unit 402 stores an image input by the input unit 304 in a memory through a bus 408. The image reading unit 406 reads the image stored in the bus 408 in a unit of image slice under control of the controller 404, and sends the same to the image processor 308. The controller 404 determines the image slice size information based on the slice number information, the image size information and the mask information, as described above, and controls the image reading unit 406 in accordance with the determined image slice size information.

Referring again to FIG. 3, the image processor 308, for example, the ISP sequentially processes the image slices received from the image slice generator 306. Further, the image merging unit 310 generates one image by merging the images processed by the image processor 308.

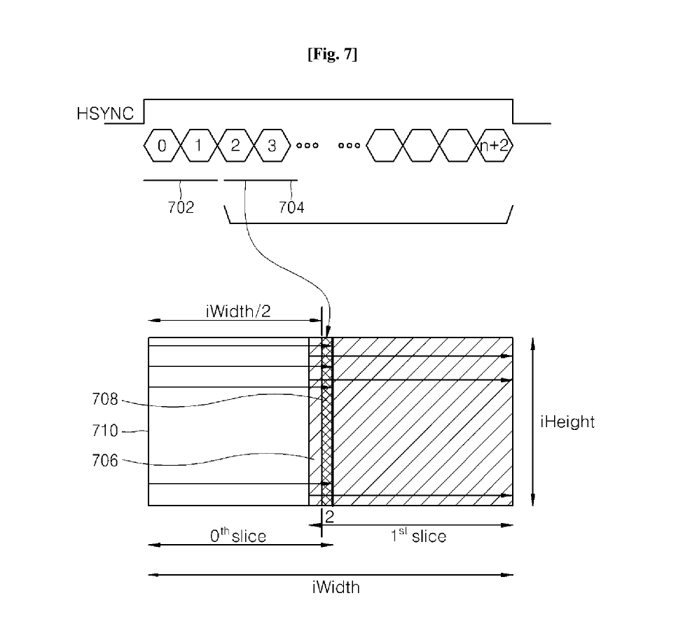

The image merging unit 310 may arrange the plurality of image slices by taking into account the boundary area between the image slices. FIG. 7 is a view explaining a process of processing a boundary between image slices in the method of image processing according to the embodiment of the present invention.

As described above, the image slice generator 306 determines the size of the image slice by taking into account the boundary area between the image slices. Therefore, the boundary area between the image slices has to be taken into account even when such image slices are merged into one image.

As described above, the width (sWidth) of the image slice generated by the image slice generator 306 is determined by adding a value (NM>>1), which is obtained by taking the mask size into account, to a value obtained by dividing the width (iWidth) of the input image by the number of images. For example, in FIG. 7, the sWidth of the 0^{th} slice and the 1^{st} slice is determined by adding a value of 2, which is obtained by taking the boundary area into account, to a value obtained by dividing iWidth by 2. These are shown as an area 708 and an area 706 in FIG. 7.

In one embodiment, the image merging unit 310 excludes pixels (for example, NM>>1) added when generating the image slice from the corresponding image slice. For example, the image merging unit 310 excludes two pixels 702 of FIG. 7 when processing the 1^{st} slice, and records two pixels 704 in the area 708. Thus, it is possible to solve image distortion due to consideration of the boundary area when dividing the image slice.

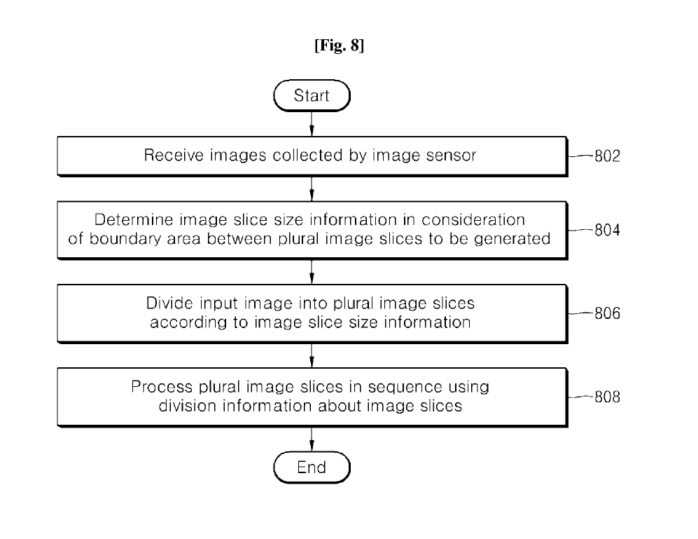

FIG. 8 is a flowchart of the image processing method according to the embodiment. First, images collected by an image sensor are received (802). Then, image slice size information is determined in consideration of a boundary area between plural image slices to be generated (804). Here, the image slice size information may be determined using slice number information, image size information, and mask information.

Next, the input image is divided into the plurality of image slices according to the determined image slice size information (806). Here, the division information may include at least one of the slice number information and the image size information. Then, the plural image slices are sequentially processed using the division information about the image slice (808).

Although not shown in FIG. 8, the image processing method according to the embodiment may further include merging the plurality of sequentially processed image slices by taking the boundary area into account. Also, the process of merging the plurality of image slices may include storing the plurality of image slices except for pixels added in determination of the image slice size information.

According to embodiments, an image is processed in a unit of image slice within a limit allowable by a memory bandwidth, thereby reducing the size of the line-buffer of the ISP and the size of the whole image processing module. Also, the image processing method according to the present invention guarantees compatibility with the existing ISP.

As such, the image processing apparatus and method according to the present invention processes each image collected by the image sensor by dividing the collected image into a plurality of image slices, thereby reducing the amount of memory used in image processing and the overall size of the image module.

Although some exemplary embodiments have been described herein, it should be understood by those skilled in the art that these embodiments are given by way of illustration only, and that various modifications, variations and alterations can be made without departing from the spirit and scope of the invention. The scope of the present invention should be defined by the appended claims and equivalents thereof.

What is claimed is:

1. A method of processing an image collected by an image sensor, comprising:
receiving an image collected by an image sensor;
determining image slice size information by taking into account a boundary area between a plurality of image slices to be generated;
dividing the image into the plurality of image slices according to the image slice size information; and
processing the plurality of image slices in sequence using division information about the image slices.

2. The method according to claim 1, wherein the image slice size information is determined using slice number information, image size information, and mask information.

3. The method according to claim 2, wherein the image slice size information is defined by Expression 1:
sWidth=(iWidth/n)+(NM>>1); and
sHeight=iHeight,
where sWidth is a width of the image slice, sHeight is a height of the image slice, iWidth is a width of the image, iHeight is a height of the image, n is the number of image slices, and NM is the size of a mask used in image processing.

4. The method according to claim 1, wherein the division information comprises at least one of the slice number information and the image size information.

5. The method according to claim 1, further comprising: merging the plurality of sequentially processed image slices by taking the boundary area into account.

6. The method according to claim 5, wherein the merging the plurality of image slices comprises storing the plurality of image slices except for pixels added in determination of the image slice size information.

7. An apparatus for processing an image collected by an image sensor, comprising:
an input unit which receives an image collected by an image sensor;
an image slice generator which determines image slice size information by taking into account a boundary area between a plurality of image slices to be generated, and divides the image into the plurality of image slices according to the image slice size information; and
an image processor which processes the plurality of image slices in sequence using division information about the image slices.

8. The apparatus according to claim 7, wherein the image slice generator determines the image slice size information based on slice number information, image size information and mask information.

9. The apparatus according to claim 8, wherein the image slice size information is defined by Expression 1:
sWidth=(iWidth/n)+(NM>>1); and
sHeight=iHeight,
where sWidth is a width of the image slice, sHeight is a height of the image slice, iWidth is a width of the image, iHeight is a height of the image, n is the number of image slices, and NM is the size of a mask used in image processing.

10. The apparatus according to claim 7, wherein the division information comprises at least one of the slice number information and the image size information.

11. The apparatus according to claim 7, further comprising: an image slice merging unit which merges the plurality of sequentially processed image slices by taking the boundary area into account.

12. The apparatus according to claim 11, wherein the image slice merging unit stores the plurality of image slices except for pixels added in determination of the image slice size information.
